(19) United States
(12) Patent Application Publication
(10) Pub. No.: US 2026/0032112 A1
(43) Pub. Date: Jan. 29, 2026

(54) SYSTEM AND METHOD FOR USING CLIENT-BASED LOGIN CERTIFICATES FOR REMOTE APPLICATIONS

(71) Applicant: Workspot, Inc., Campbell, CA (US)

(72) Inventors: Edward A. Seidman, Rochester, NY (US); Timothy H. Root, Santa Cruz, CA (US); Amitabh Bhuvangyan Sinha, San Jose, CA (US); Jimmy Chang, Mountain View, CA (US)

(21) Appl. No.: 19/276,900

(22) Filed: Jul. 22, 2025

Related U.S. Application Data
(60) Provisional application No. 63/675,955, filed on Jul. 26, 2024.

(51) Int. Cl. H04L 9/40; G06F 9/455

(52) U.S. Cl. CPC H04L 63/0823; G06F 9/45558; H04L 63/0815; G06F 2009/45587

(57) ABSTRACT

A system and method for providing a single sign-on for connecting a client device to a virtual infrastructure. The virtual infrastructure includes a server, an enterprise connector and a certificate authority. The client device receives an identity provider (IdP) token obtained from an IdP on authenticating a user of the client device. On authentication of the user, a desktop client application on the client device sends a request through the enterprise authority for a login certificate. A login certificate generated by the certificate authority is received by the client device. The login certificate to the client device is sent to the virtual infrastructure to allow the client device a connection to a virtual machine of the virtual infrastructure.

### PRIORITY CLAIM

The present disclosure claims priority to and benefit of U.S. Provisional Application No. 63/675,955 filed on Jul. 26, 2024. The contents of that application are hereby incorporated by reference in their entirety.

### TECHNICAL FIELD

The present disclosure relates generally to Cloud-based virtual application systems. More particularly, aspects of this disclosure relate to establishing secure log in certificates for remote applications executed by end point devices using a single sign in for the end point device.

### BACKGROUND

Computing systems that rely on applications operated by numerous networked computers are ubiquitous. Information technology (IT) service providers thus must effectively manage and maintain very large-scale infrastructures. An example enterprise environment may have many thousands of devices and hundreds of installed software applications to support. The typical enterprise also uses many different types of central data processors, networking devices, operating systems, storage services, data backup solutions, cloud services, and other resources. These resources are often provided by means of cloud computing, which is the on-demand availability of computer system resources, such as data storage and computing power, over the public internet or other networks without direct active management by the user.

Cloud-based remote desktop virtualization solutions have been available for over a decade. These solutions provide virtual desktops to network users with access to public and/or private clouds. In cloud-based remote desktop virtualization offerings, there is typically a capability of associating a remote desktop virtualization template in a particular cloud region with a remote desktop virtualization pool in the same cloud region as part of the general configuration model. This remote desktop virtualization template is customized with the image of the right desktop for a particular remote desktop virtualization use case.

A cloud desktop service system provides cloud applications such as virtual desktops or other remote applications that are allocated from public or private cloud providers. In some cases, the cloud provider and cloud region are already selected. Users of cloud desktops access a computer desktop, or specific desktop application, using a local endpoint device. Each cloud desktop exists within a non-virtual computer known as a host. Some cloud providers may expose the existence of hosts and require that use of a host not be shared between multiple customers, for licensing or other reasons. For that or other reasons a cloud desktop service system may need to manage the allocation of virtual machines onto specific hosts.

A user may connect a display and input device to a cloud desktop, which is a target virtual machine functioning as a remote desktop or remote application host to engage in a remote display session via a certain connection pathway. The term pathway refers to a sequence of hardware and software processing steps that a remote display connection request requires.

Typically, access to a client application on an endpoint device is protected from unauthorized use through a sign on process that must be followed by the user. For example, an Identity Provider (IdP) may be required to allow identification and authentication of the user. In known virtual desktop systems, another level of security is added to allow access by the endpoint device to the virtual desktop. A smart card reader with an authentication protocol and associated certificate authority is a well-known method to allow user login without a username and password for computers on a network. When using a remote Cloud Desktop/Application, sometimes called virtual display infrastructure (VDI), that same experience is desirable using a smart card reader attached to a client device.

Requiring a separate authentication process for accessing a remote cloud desktop/application is cumbersome for users who have already accessed the client application using Identity Provider (IdP) credentials as another protocol such as Microsoft Active Directory (AD) credentials are required. This undermines the desired experience of simulating a local computing resource. A single sign-on (SSO) process for any type of endpoint device with the client desktop application using standard Active Directory components in the virtual infrastructure requires caching that user password, which is against corporate policy for many organizations. Using a login certificate, such as a smart card certificate, bypasses this problem, but requires the user to have enrolled their smart card, typically on a physical Smart Card device. This causes additional difficulties in distributing the certificates as a secure infrastructure to distribute the certificates must be set up and there must be a mechanism so only legitimate users get the login certificates through Multi Factor Authentication (MFA).

FIG. 1 shows a prior art virtual desktop system 10 that includes a client device 12 and a virtual infrastructure 14. The client device 12 includes a remote display client 20 that communicates with a gateway 30 of the virtual infrastructure 14 using a gateway and login certificate validator on a virtual machine. The virtual infrastructure 14 also includes a certificate authority 32. A group of servers such as in a regional data center create a group of virtual machines 40. The virtual machines 40 are accessible through a specific server system 42. The server system 42 includes a remote display server application 44 and a login certificate validator 46.

In a known system, an identity provider (IdP) 50 grants a token representing valid credentials. An Okta identity solution generating a JSON Web Token (JWT) is an example of the IdP 50. The client device 12 executes the remote display client 20 after the token is generated. The remote display client 20 is software that sends user input to the cloud desktop/application and renders a remote display for the user on the client device 12.

The client device 12 communicates with the virtual infrastructure 14 via a remote display protocol, which is a method for communication used to implement the virtual display infrastructure. Examples of a remote display protocol include the Remote Desktop Protocol (RDP), FreeRDP, PCOIP, and ICA. The gateway 30 is a common security point for securing access to the customer virtual infrastructure 14. The gateway 30 may be a Microsoft RDP Gateway or a Citrix Gateway.

The remote display server application 44 is software that implements some remote display protocol (such as RDP) on the virtual machine 40. The login certificate validator 46 is software running within the virtual infrastructure 14 that can validate a presented login certificate. An example of a login certificate validator is the Virtual Delivery Agent (VDA). A certificate authorization protocol is a system for managing authorization for internet-based applications such as Kerberos. The certificate authority 32 is a component capable of generating virtual login certificates such as smart card certificates. An example certificate authority is a Microsoft certificate authority. The prior art system 10 does not need to store the credentials on the client, because the gateway 30 has the ability to use the IdP credentials to query the certificate authority (CA), and can get the certificate, which they can then use to log in. This approach requires specialized certificate software and supporting hardware components in the virtual infrastructure 14. However, when using standard Microsoft components and protocols, the separate certificate and authentication is required because a standard Microsoft Gateway and the RDP protocol does not allow for passing IdP credentials. As a result, the certificate must be obtained from the remote display client 20 so it can be passed through the RDP protocol, which supports smartcard certificate login.

Thus, there is a need for a mechanism that allows a user of a remote end device to perform a single sign-on process to access the virtual desktop infrastructure. There is a further need for a method to provide single sign-on that does not require specialized applications for security protocols. There is also a need to conserve gateway resources from being involved in sign-on procedures to a virtual desktop infrastructure.

### SUMMARY

One disclosed example is a system for providing a single sign-on for a client device. The system includes a virtual infrastructure that provides a virtual machine to the client device in communication with the virtual infrastructure. The virtual infrastructure has a server, an enterprise connector, and a certificate authority generating login certificates. A credential service is coupled to the enterprise connector and the client device. An interface provides communication via a remote display protocol between the virtual machine and a client display application executed on the client device. When a user of the client device is authenticated by an identity provider to execute the client display application, a login certificate is received from the certificate authority through the enterprise connector and the credential service. The login certificate is sent to the virtual infrastructure to allow the client device access to the virtual machine by the client device through the remote display protocol.

In another implementation of the disclosed example system, the identity provider sends a token to the client device to allow the user to execute the client display application to send the stored login certificate to the virtual infrastructure. In another implementation, the login certificate has an expiration period and is stored in a security container on the client device. In another implementation, the client device includes a credential controller that checks the stored login certificate and determines if the login certificate has expired in a subsequent authentication of the user. If the login certificate has not expired, the stored login certificate is sent to the virtual infrastructure to allow the client device access to the virtual machine by the client device through the remote display protocol. In another implementation, the security container is a virtual smart card stored on a Trusted Platform Module of the client device or an encrypted storage of the client device. In another implementation, the token is sent to the credential service to request the generation of the login certificate from the certificate authority through the enterprise connector. In another implementation, the example system includes a desktop control plane coupled to the virtual infrastructure and the client device. The credential service is part of the desktop control plane. In another implementation, the interface is a gateway in communication with the virtual machine and the client device. The user is an external user to the virtual infrastructure and on sending the login certificate, the gateway allows communication between the virtual machine and the client device. In another implementation, the client device is a component of the virtual infrastructure. The user is an internal user and on sending the login certificate and direct communication between the virtual machine and the client device is allowed. In another implementation, the certificate authority is a Microsoft Active Directory system.

Another disclosed example is a method for allowing a single sign-on for connecting a client device to a virtual machine generated by a virtual infrastructure. The virtual infrastructure includes a server executing the virtual machine, an interface to the client device, an enterprise connector and a certificate authority. Authentication by an identity provider of a user of the client device is received through the enterprise connector. The authentication provided by the identity provider is verified. A login certificate is generated by the certificate authority. The login certificate is sent to a client display application executed on the client device. The login certificate sent from the client device is received at the virtual infrastructure. Communication between the client device and the virtual machine is allowed on receiving the login certificate.

In another implementation of the disclosed example method, the identity provider sends a token to the client device to allow the user to execute the client display application using the login certificate to the virtual infrastructure. In another implementation, the login certificate has an expiration period and is stored in a security container on the client device. In another implementation, the example method includes on a subsequent authorization of the user, checking the stored login certificate to determine if the login certificate has expired. The stored login certificate is sent by the virtual infrastructure if the login certificate has not expired. Communication is allowed between the client device and the virtual machine on receiving the stored login certificate. In another implementation, the security container is a virtual smart card stored on a Trusted Platform Module of the client device or an encrypted storage of the client device. In another implementation, the token is sent to a credential service to request the generation of the new login certificate from the certificate authority through an enterprise connector. In another implementation, a credential service is part of a desktop control plane coupled to the client device and the virtual infrastructure. The credential service receives the generated login certificate through the enterprise connector and sends the login certificate to the client device. In another implementation, a gateway is in communication with the virtual desktop and the client device and the user is an external user to the virtual infrastructure. On sending the login certificate, the gateway allows communication between the virtual machine and the client device. In another implementation, the client device is a component of the virtual infrastructure, and the user is an internal user. On sending the login certificate, direct communication between the virtual machine and the client device is allowed.

Another disclosed example is a non-transitory computer-readable medium having machine-readable instructions stored thereon. When executed by a processor the instructions cause the processor to receive authentication by an identity provider of a user of the client device through an enterprise connector of a virtual infrastructure. The instructions cause the processor to validate the authentication provided by the identity provider. The instructions cause the processor to generate a login certificate by a certificate authority. The instructions cause the processor to send the login certificate to a client display application executed on the client device. The instructions cause the processor to receive the login certificate at the virtual infrastructure. The instructions cause the processor to allow communication between the client device and the virtual machine on receiving the login certificate.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1 is a diagram showing a prior art log in agent for allowing an endpoint device to a virtual desktop infrastructure;

FIG. 2 is a diagram of an example virtual desktop system incorporating client device based sign-ins to access the virtual desktop infrastructure;

FIG. 3 is a detailed block diagram of the components of the virtual desktop system in FIG. 2 that allow a client device to use a single sign-on process to access the virtual desktop infrastructure using a stored certificate;

FIG. 4 is a process flow diagram of the routine to provide a user of a client device a single sign-on to access a virtual desktop infrastructure;

FIG. 5 is a detailed block diagram of an alternate arrangement of the components of the virtual desktop system in FIG. 2 that allow a client device to use a single sign-on to access the virtual desktop infrastructure using a stored certificate in a smart card; and

FIGS. 6 and 7 illustrate exemplary computer systems in accordance with various examples of the present disclosure.

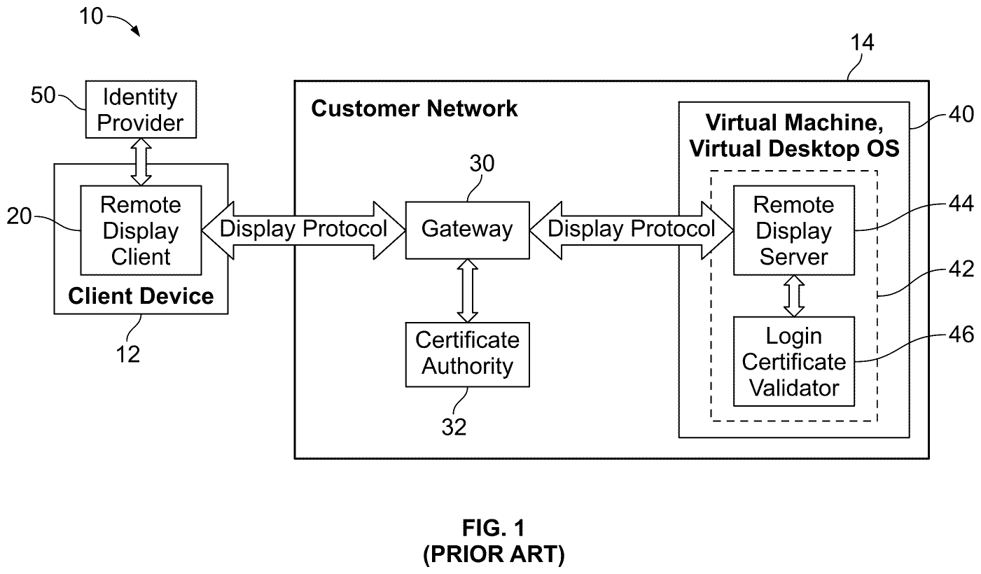

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure relates to a method that allows users of end point devices to perform authentication with an external identity provider (IdP) and use these credentials to obtain a smart card certificate for access to a virtual desktop infrastructure. The example method thus allows a single sign-on for a user of an endpoint device to access both the remote desktop client application and the virtual desktop infrastructure. This is achieved using a credential service to transmit the requests with an IdP token and an enterprise connector to communicate the login certificate with a certificate authority. The client device stores the login certificate in a secure login certificate container such as a virtual smart card based on a trusted platform module (TPM) or other protected storage and uses the certificate to log into a remote desktop generated by the virtual desktop infrastructure.

The advantages of the example method include allowing single sign-on (SSO) by a user operating a client device to access a virtual desktop infrastructure and an Open ID Connect (OIDC) compliant identity provider. A standard remote display protocol (RDP) service can be used in conjunction with the example SSO process. A protocol gateway such as an RDP gateway is not required for the example SSO process and thus client devices can connect directly to the virtual resources if desired. The example method allows a single sign-on to a virtual infrastructure that includes a Microsoft standard RDP protocol and Microsoft standard gateways without the need for a specialized component. Thus, the example method does not require creating a login agent that is built into the virtual infrastructure to run on the cloud desktop/cloud application virtual machine.

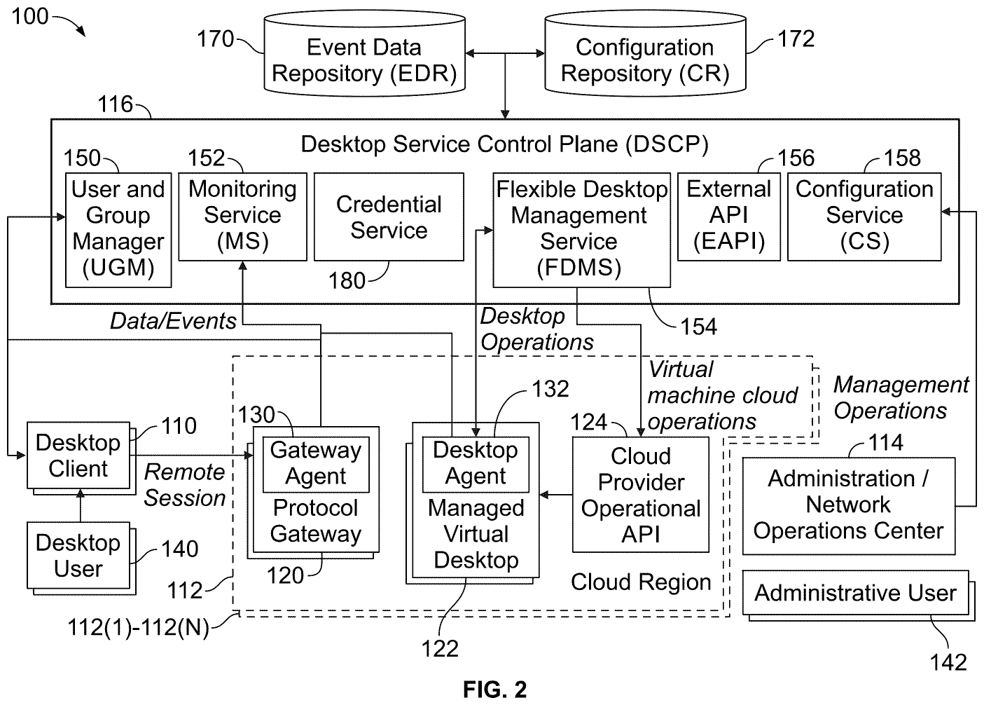

FIG. 2 is a block diagram of some examples of components of a Cloud desktop service system 100, which serves as a virtual desktop system. The system 100 includes an example set of desktop clients 110, a Cloud region 112, and an administration center 114, that interact with and can be orchestrated by a desktop service control plane 116. The desktop client 110 communicates with the desktop service control plane 116 in order to be registered with the fabric, assigned a desktop, remotely configured, and for other purposes. One other purpose is to monitor latency, response-time, and possibly other data and events that measure quality of user experience. Another purpose is to report user interaction events. There may be multiple Cloud regions (e.g., cloud regions 112(1) to 112(N)) similar to the Cloud region 112, but only one Cloud region 112 is shown in detail for simplicity of explanation. The Cloud region 112 may include a set of protocol gateways 120, a set of managed virtual desktops or virtual machines 122, and a cloud service provider operational API 124. These components all communicate with the desktop service control plane 116. The Cloud region 112 may be one of several Cloud regions.

Such Cloud regions include servers that host the various applications as well as appropriate storage capabilities, such as virtual disks, memory, and network devices. Thus, the Cloud region 112 typically comprises IT infrastructure that is managed by IT personnel. The IT infrastructure may include servers, network infrastructure, memory devices, software including operating systems, and so on. If there is an issue related to an application reported by a user, the IT personnel can check the health of the infrastructure used by the application. A Cloud region may include a firewall to control access to the applications hosted by the Cloud region. The firewall enables computing devices behind the firewall to access the applications hosted by the cloud region, but prevents computing devices outside the firewall from directly accessing the applications. The firewall may allow devices outside the firewall to access the applications within the firewall using a virtual private network (VPN).

The protocol gateway 120 may be present to provide secure public or internal limited access to the managed virtual desktops, that may be deployed on a virtual machine of its own. A gateway agent 130 is software that is deployed on that gateway virtual machine by the desktop service control plane 116, and serves to monitor the activity on the gateway 120, and enable the desktop service control plane 116 to assist in configuration and operations management of the gateway 120.

The example desktop client 110 is software and device hardware available in the local environment of a desktop user 140 to remotely access a managed virtual desktop using a remote desktop protocol. The desktop client 110 communicates with the desktop service control plane 116 to monitor latency, response-time, and other metrics to measure quality of user experience and also supports a remote display protocol in order for users to connect to a desktop application run by the cloud region 112.

The managed virtual desktop 122 is itself provisioned and maintained by the desktop service control plane 116. A desktop template may be used to manage pools of such managed virtual desktops. The desktop template is used to instantiate virtual desktops with the correct virtual machine image and a standard set of applications for a particular use case. A desktop agent such as desktop agent 132 is software that is deployed on that managed virtual desktop by the desktop service control plane 116, and serves to monitor the activity on the managed virtual desktop, and enable the desktop service control plane 116 to assist in configuration and operations management of the managed virtual desktop.

The Cloud service provider operational application programming interface (API) 124 presents services provided by the Cloud service provider that also participate in the management of the virtual machine. This can be utilized by a desktop service control plane 116 to perform operations like provisioning or de-provisioning the virtual machine.

Administrative users 142 can interact with operations reporting interface software at the administration center 114 that allows management and administration of the desktop service control plane 116.

Other components and services may interact with the desktop service control plane but are omitted from FIG. 2 for simplicity, such as enterprise connectors, network monitoring services, customer relationship management (CRM) systems, and many others.

The desktop service control plane 116 itself can perform many internal centralized functions also not depicted in in FIG. 2, including pool management, user and group management, cloud service adapters, virtual desktop templates, data analysis, high-availability management, mapping users to the optimal Cloud region, security policy management, monitoring, compliance, reporting, and others.

The control plane 116 includes a user and group manager 150, a monitoring service 152, a desktop management service (DMS) 154, an external API (EAPI) 156, and a configuration service (CS) 158. The control plane 116 may access an event data repository 170 and a configuration repository 172. Although only one Cloud region 112 is shown in detail, it is to be understood that the control plane 116 may facilitate numerous Cloud regions such as the Cloud regions 112(1)-112(N).

The monitoring service 152 makes both routine and error events available to administrators and can analyze operational performance and reliability. The monitoring service 152 interacts with components including the desktop client 110, gateway agent 130, and desktop agent 132 to obtain operational data relating to the desktop, and operational data generated by the control plane 116 itself. The monitoring service 152 stores all such operational data for later analysis. As will be explained desktop clients may report information about the location of the user. Desktop agents can report information about the duration of each connection, and other performance information, including the applications used by the desktop. Gateway agents can also report performance information because the gateway agent sits between the desktop client and the desktop on the network.

The desktop management service 154 interacts with the one or more managed virtual machines (MVMs) 122 in the cloud region 112 and other cloud regions 112(1) to 112(N). In this example, the desktop management service 154 manages resources for providing instantiated desktops to the users in the logical pools, orchestrating the lifecycle of a logical desktop. As will be explained, the management service 154 includes a credential service 180 that facilitates a single sign-on for users of the client devices that request access to virtual machines in the Cloud region 112.

The administration center 114 works directly with the desktop service control plane 116 as its primary human interface. The administration center 114 allows the administrative user 142 to configure the functions of the control plane 116 through the configuration service 158. The configuration service 158 supports editing and persistence of definitions about the desktop service, including subscription information and policies. The administration center 114 may be where the desktop requirement dimensions are configured by the administrative user 142. The system 100 allows the creation and management of desktop pools in accordance with the process described herein.

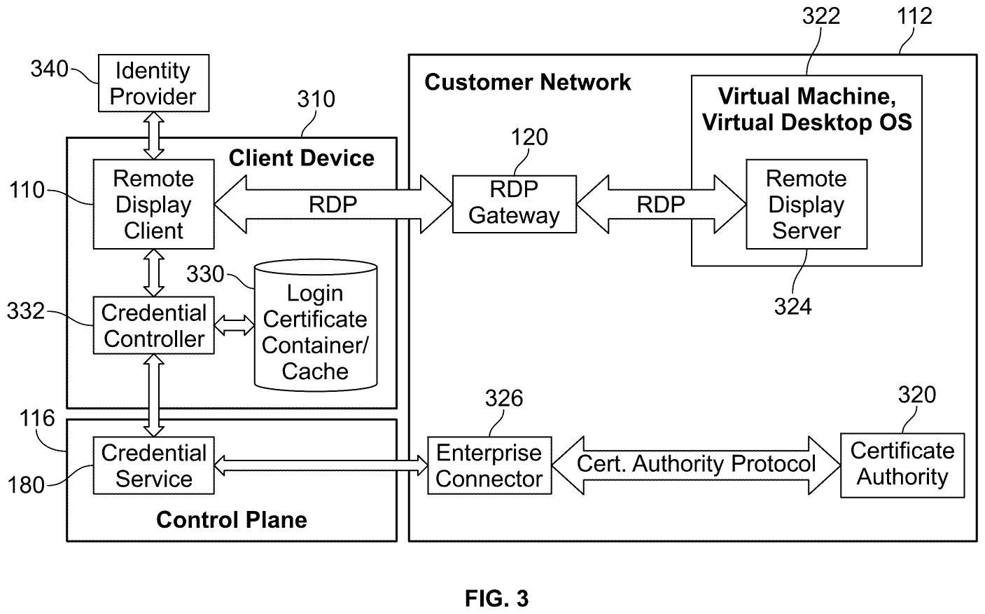

FIG. 3 is a block diagram of the components in FIG. 2 used for executing the example method of single sign-on from a client device 310 to access a virtual desktop infrastructure such as the Cloud region 112. FIG. 3 shows the client device 310, the virtual infrastructure in the form of the Cloud region 112, and the desktop service control plane 116.

The client device 310 includes the remote display client 110 that communicates with the gateway 120 of the virtual infrastructure in the Cloud region 112 in FIG. 2. The remote display client 110 uses the example single sign-on method to avoid using the gateway 120 to communicate with the security components of the virtual infrastructure 112 responsible for ensuring the client device 310 has proper credentials. The infrastructure 112 includes a certificate authority 320. The certificate authority (CA) 320 is a trusted entity that issues and manages digital login certificates. Certificate authorities act as a trusted third party, verifying the identity of entities such as websites, organizations, or individuals, and issuing digital certificates that contain information about that entity, including its public key.

A group of servers in the infrastructure 112 create a virtual machine 322. The virtual machine 322 runs a remote display server application 324. The client device 310 communicates with the virtual infrastructure 112 through the gateway 120 via a remote display protocol to communicate with the virtual machine 322. An example of a remote display protocol include the Remote Desktop Protocol (RDP), FreeRDP, PCOIP, and ICA. The remote display server 324 is software that implements some remote display protocol (such as RDP) on the virtual machine 322. The gateway 120 is protected by a certificate authorization system such as Kerberos that manages authorization of Internet-based applications.

As explained above, the certificate authority 320 is a component capable of generating virtual login certificates such as smart card certificates. In this example, the certificate authority 320 is a Microsoft Active Directory (AD) Certificate Authority. The virtual infrastructure 112 includes an enterprise connector 326. The enterprise connector 326 is a secured adapter for accessing services within a security environment such as the virtual infrastructure. In this example, the enterprise connector 326 is used to access the certificate authority 320 in the customer network/security boundary defined by the Cloud region 112. The enterprise connector 326 is a software component that runs in the enterprise environment, and allows for a secure connection between the cloud based control software, and Active Directory servers in the enterprise environment. This is necessary because Active Directory servers are almost never exposed to the Internet. The enterprise connector 326 uses a reverse connection approach to ensure that only the authorized cloud resources can get access.

In this example, the client device 310 includes a login certificate security container/cache 330. In this example, the container/cache 330 stores a login certificate. In this example the container/cache 330 is a storage system of the client device 310 that allows encrypted storage of data such as the login certificate. The container/cache 330 optionally can cache certificates for performance reasons. This optimizes operations by allowing a client device to login using a saved certificate for a limited amount of time. The container/cache 330 may be an off-the-shelf or custom-made component. One example of an off the shelf component is the Microsoft Virtual Smart Card. On non-Microsoft systems, a custom encrypted certificate store may be developed to hold the certificates.

The remote display client 110 is in communication with an identity provider 340. The identity provider 340 issues an IdP token after having the user prove their identity. Once the IdP token is received from the identity provider 340, the user may access the remote display client application 110. The client device 310 includes a credential controller 332. The credential controller 332 stores and retrieves login certificates from the container/cache 330. The credential controller 332 communicates the login certificates from the credential service 180 managed via the Cloud desktop service control plane 116. The credential service 180 is used to obtain the IdP token from the client device 310 when requesting a login certificate. The IdP token is then passed through to the enterprise connector 326. Either the credential service 180 or the enterprise connector 326 then validates the IdP token to prove identity of the user and obtains a login certificate if required from the certificate authority 320.

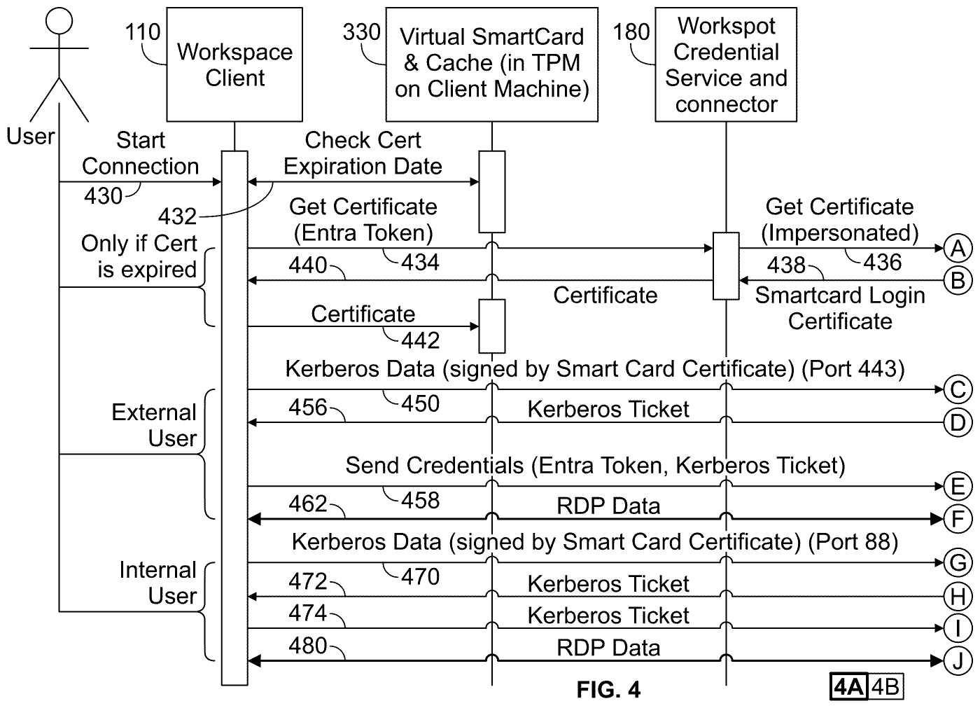

FIG. 4 is a process diagram showing the example single sign-on process by the client device 310 to the virtual infrastructure 112 and other associated routines. The processes for allowing a single sign-on is conducted between a user, the remote display client 110, the container/cache 330, the credential service 180 on the control plane 116, a certificate server 410 that executes the certificate authority 320 in FIG. 3, a remote desktop (RD) gateway service 412 (gateway agent 130 in FIG. 2), a key distribution center (KDC) proxy 414, a Kerberos key distribution center 416, and a host 418. In this example, the gateway service 412 also runs the KDC proxy 414. The host 418 represents a virtual desktop that may be run on the virtual machine 322 in FIG. 3 and other components of the virtual infrastructure 112. As explained above, the client device 310 that executes the remote display client 110 may have a token such as a JSON web token (JWT) that is obtained from the identity provider 340 in FIG. 3 once the identity of the user is verified by the identity provider 340. The example method allows the user of the client device 310 to access the virtual desktop simply by obtaining the token, without entering (or even knowing) their Microsoft Active Directory (AD) credentials. In this example, the Microsoft Active Directory service centrally manages and authenticates users, computers, and resources in a Windows domain network such as the virtual infrastructure 112. However, the credentials for the Active Directory service are automatically obtained by and stored in the client device 310 and may be communicated automatically when the user is verified by the identity provider 340 in FIG. 3.

A user first initiates the connection by starting the remote display client 110 on the client device 310 (430). The connection includes obtaining an IdP token from the identity provider 340 in FIG. 3 once the user verifies their identity. The user is then allowed to operate the remote display client 110.

In this example, the remote display client 110 checks the certification expiration date of the login certificate in the container or cache 330 (432) to determine if the stored login certificate is unexpired. If the login certification is expired, or there is no saved login certificate, then a new login certificate is requested from the credential service 180 through the enterprise connector 326 (434). The request is initiated by passing the IdP token to the credential service 180. In this example, either the credential service 180 or the enterprise connector 326 authenticates the IdP token. Once the IdP token is authenticated, the credential service 180 requests a login certificate via the enterprise connector 326 in FIG. 3 on behalf of the validated user identity. The request is sent to the certificate server 410 that includes the certificate authority 320. The certificate server 410 issues the new login certificate. In this example, the certificate server 410 generates a login certificate and sends the login certificate to the credential service 180 via the enterprise connector 326 (438). The credential service 180 sends the login certificate to the remote display client 110 through the credential controller 332 (440). The new login certificate is stored as the login certificate in the container 330 (442).

The remote display client 110 needs to use the login certificate to get a Kerberos ticket to access the virtual machine (host 418). If the stored login certificate is unexpired (432), the login certificate is sent to the KDC 416 to issue a Kerberos ticket to allow access through the gateway service 412. As explained above, if the logon certificate stored in the container 330 is expired, a new login certificate is obtained from the certificate server 410 through the credential service 180. If the user is on a device that is in the internal network, then the Kerberos request goes directly to the KDC 416. If the user is on a device that is not inside of the internal network, then the request goes through the Kerberos proxy 414.

The remote display client 110 will send the credentials in the form of the Kerberos ticket through the RDP protocol to authenticate the user to the host, and optionally to the gateway service also. The Kerberos ticket satisfies the Active Directory authentication requirements, replacing the username/password. The session between the remote display client 110 and the virtual desktop (host 418) can be established, and display and control data can then be sent via the RDP protocol through the gateway 120.

As shown in FIG. 4, an external user will send Kerberos data signed by the valid login certificate stored on the container 330 to the KDC proxy 414 run on the gateway 120 in FIG. 3 (450). The KDC proxy 414 will send the Kerberos data through the Kdata port 88 to the Kerberos key distribution center 416 (452). The Kerberos key distribution center 416 will authenticate the Kerberos data and send a Kerberos ticket to the KDC proxy 414 (454). The KDC proxy 414 sends the Kerberos ticket to the remote display client 110 (456).

The remote display client 110 will send the credentials in the form of the Kerberos ticket and optionally an IdP token to the gateway service 412 (458). The IdP token can be used to authenticate to the gateway service 412, which then sends only the Kerberos ticket to the host 418 to authorize communication with the client device 310 (460). The remote display client 110 then may send RDP data through the gateway service 412 to the host 418 (462). The host 418 allows RDP data to be sent to the remote display client 110 through the gateway service 412 (464).

An internal user will send Kerberos data signed by the login certificate directly to the Kerberos key distribution center 416 (470). The Kerberos key distribution center 416 will authenticate the Kerberos data and send a Kerberos ticket to the remote display client 110 (472). The remote display client 110 will send the Kerberos ticket to the host 418 (474). Once verified, the host 418 then allows RDP data exchanged directly with the remote display client 110 (480).

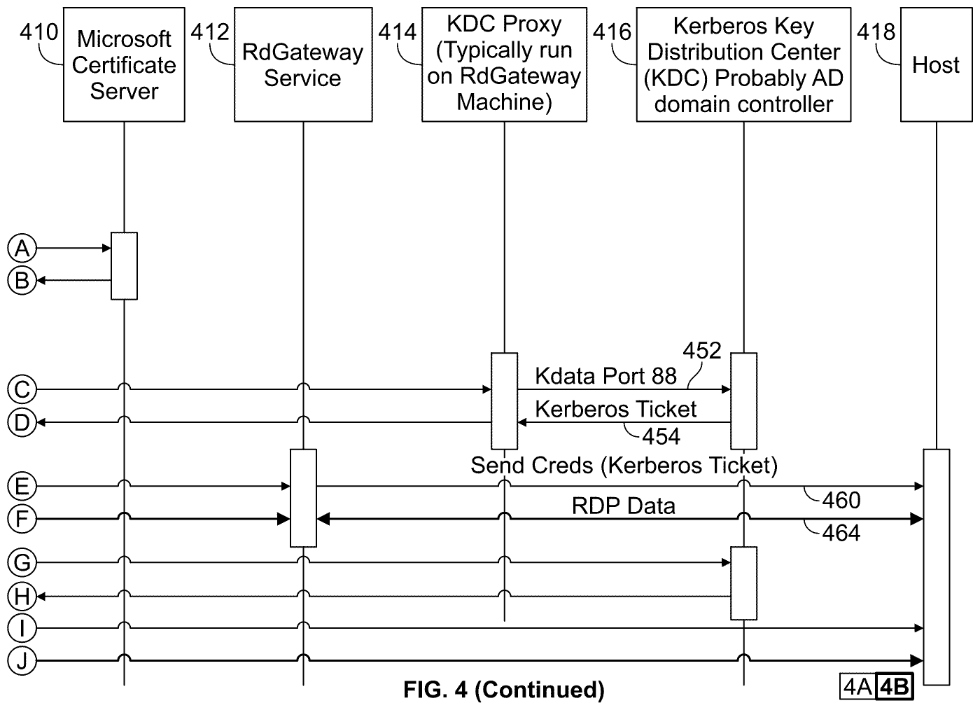

FIG. 5 is a block diagram of an alternative arrangement of the components in FIG. 2 used for executing the example method of single sign-on from a different client device 510 to access a virtual desktop infrastructure such as the Cloud region 112. FIG. 5 shows the client device 510 that executes the remote display client 110, and the virtual infrastructure in the form of the Cloud region 112, and the desktop service control plane 116.

Similar to the system in FIG. 3, the client device 510 includes the remote display client 110 that communicates with the gateway 120 of the virtual infrastructure in the Cloud region 112 in FIG. 2. The remote display client 110 uses the example single sign-on method to avoid using the gateway 120 to communicate with the security components of the virtual infrastructure 112 responsible for ensuring the client device 310 has proper credentials.

As explained in reference to FIG. 3, the infrastructure 112 includes the certificate authority 320, servers that create the virtual machine and the remote display server application 324. The client device 510 communicates with the virtual infrastructure 112 through the gateway 120 via a remote display protocol to communicate with the virtual machine 322. The virtual infrastructure 112 includes the enterprise connector 326 that is used to access the certificate authority 320 in the customer network/security boundary defined by the Cloud region 112.

The client device 510 includes a login certificate container 530 and a credential controller 532. In this example, the certificate container 530 is a Microsoft Virtual Smart Card that emulates a physical smart card using the trusted platform module (TPM) of the client device 510 to provide secure two-factor authentication without requiring additional hardware. The login certificate stored in the virtual smart card in the container 530 and is accessible on the client device 510. The login certificate is thus stored in the TPM, which is a specialized chip on a motherboard of the client device that provides hardware-based security functions. TPMs securely store cryptographic keys, passwords, and certificates.

The credential controller 532 stores and retrieves login certificates stored in the virtual smart card and cache 530 and communicates with the credential service 180 managed via the Cloud desktop service control plane 116. The credential service 180 obtains a login certificate from the credential controller 532 and passes the login certificate through the enterprise connector 326 to the certificate authority 320 to validate the client device 510. Once validated, the client device 510 may access the virtual machine 322 through the gateway 120.

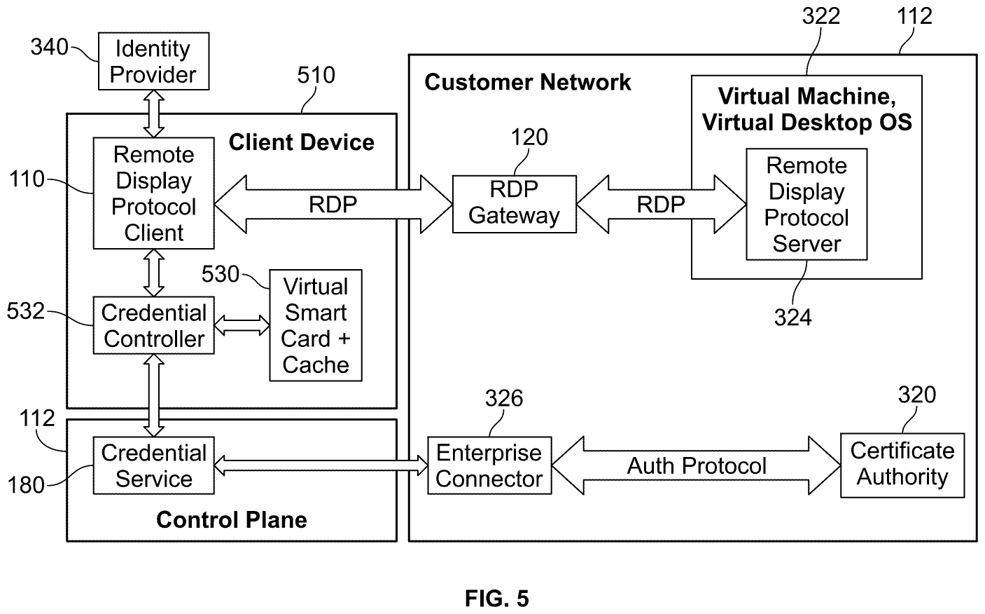

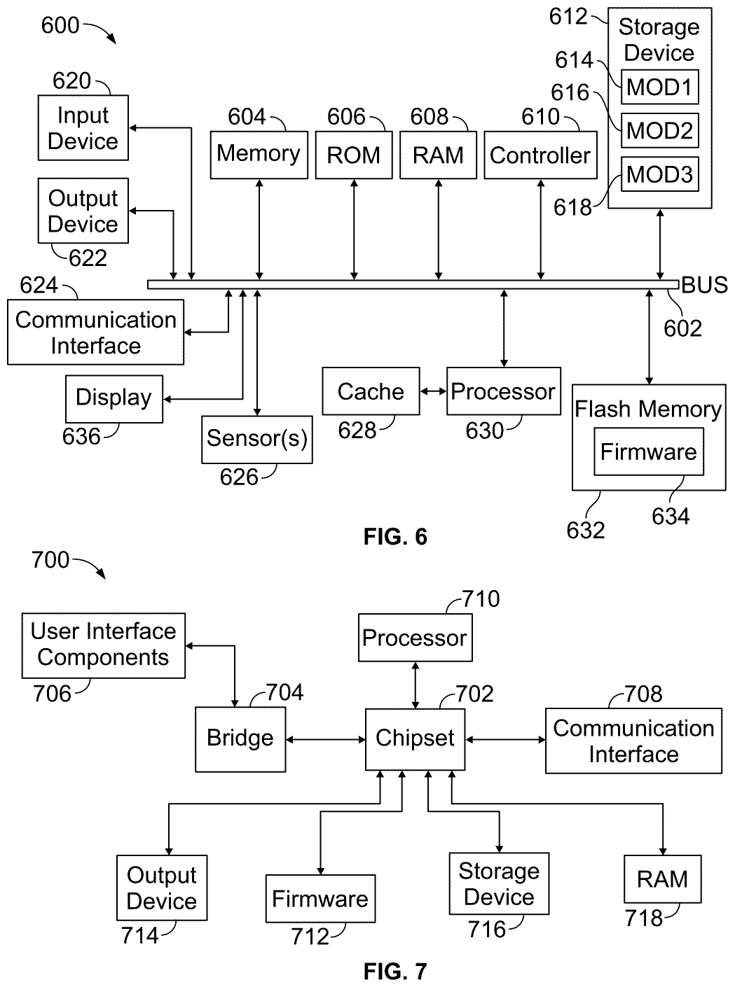

FIGS. 6-7 illustrate an example computing system 600, in which the components of the computing system are in electrical communication with each other using a bus 602. The system 600 includes a processing unit (CPU or processor) 630 and a system bus 602 that couple various system components, including the system memory 604 (e.g., read only memory (ROM) 606 and random access memory (RAM) 608), to the processor 630. The system 600 can include a cache of high-speed memory connected directly with, in close proximity to, or integrated as part of the processor 630. The system 600 can copy data from the memory 604 and/or the storage device 612 to the cache 628 for quick access by the processor 630. In this way, the cache can provide a performance boost for processor 630 while waiting for data. These and other modules can control or be configured to control the processor 630 to perform various actions. Other system memory 604 may be available for use as well. The memory 604 can include multiple different types of memory with different performance characteristics. The processor 630 can include any general purpose processor and a hardware module or software module, such as module 1 614, module 2 616, and module 3 618 embedded in storage device 612. The hardware module or software module is configured to control the processor 630, as well as a special-purpose processor where software instructions are incorporated into the actual processor design. The processor 630 may essentially be a completely self-contained computing system that contains multiple cores or processors, a bus, memory controller, cache, etc. A multi-core processor may be symmetric or asymmetric.

To enable user interaction with the computing device 600, an input device 620 is provided as an input mechanism. The input device 620 can comprise a microphone for speech, a touch-sensitive screen for gesture or graphical input, keyboard, mouse, motion input, and so forth. In some instances, multimodal systems can enable a user to provide multiple types of input to communicate with the system 600. In this example, an output device 622 is also provided. The communications interface 624 can govern and manage the user input and system output.

Storage device 612 can be a non-volatile memory to store data that is accessible by a computer. The storage device 612 can be magnetic cassettes, flash memory cards, solid state memory devices, digital versatile disks, cartridges, random access memories (RAMs) 608, read only memory (ROM) 606, and hybrids thereof.

The controller 610 can be a specialized microcontroller or processor on the system 600, such as a BMC (baseboard management controller). In some cases, the controller 610 can be part of an Intelligent Platform Management Interface (IPMI). Moreover, in some cases, the controller 610 can be embedded on a motherboard or main circuit board of the system 600. The controller 610 can manage the interface between system management software and platform hardware. The controller 610 can also communicate with various system devices and components (internal and/or external), such as controllers or peripheral components, as further described below.

The controller 610 can generate specific responses to notifications, alerts, and/or events, and communicate with remote devices or components (e.g., electronic mail message, network message, etc.) to generate an instruction or command for automatic hardware recovery procedures, etc. An administrator can also remotely communicate with the controller 610 to initiate or conduct specific hardware recovery procedures or operations, as further described below.

The controller 610 can also include a system event log controller and/or storage for managing and maintaining events, alerts, and notifications received by the controller 610. For example, the controller 610 or a system event log controller can receive alerts or notifications from one or more devices and components, and maintain the alerts or notifications in a system event log storage component.

Flash memory 632 can be an electronic non-volatile computer storage medium or chip that can be used by the system 600 for storage and/or data transfer. The flash memory 632 can be electrically erased and/or reprogrammed. Flash memory 632 can include EPROM (erasable programmable read-only memory), EEPROM (electrically erasable programmable read-only memory), ROM, NVRAM, or CMOS (complementary metal-oxide semiconductor), for example. The flash memory 632 can store the firmware 634 executed by the system 600 when the system 600 is first powered on, along with a set of configurations specified for the firmware 634. The flash memory 632 can also store configurations used by the firmware 634.

The firmware 634 can include a Basic Input/Output System or equivalents, such as an EFI (Extensible Firmware Interface) or UEFI (Unified Extensible Firmware Interface). The firmware 634 can be loaded and executed as a sequence program each time the system 600 is started. The firmware 634 can recognize, initialize, and test hardware present in the system 600 based on the set of configurations. The firmware 634 can perform a self-test, such as a POST (Power-On-Self-Test), on the system 600. This self-test can test the functionality of various hardware components such as hard disk drives, optical reading devices, cooling devices, memory modules, expansion cards, and the like. The firmware 634 can address and allocate an area in the memory 604, ROM 606, RAM 608, and/or storage device 612, to store an operating system (OS). The firmware 634 can load a boot loader and/or OS, and give control of the system 600 to the OS.

The firmware 634 of the system 600 can include a firmware configuration that defines how the firmware 634 controls various hardware components in the system 600. The firmware configuration can determine the order in which the various hardware components in the system 600 are started. The firmware 634 can provide an interface, such as an UEFI, that allows a variety of different parameters to be set, which can be different from parameters in a firmware default configuration. For example, a user (e.g., an administrator) can use the firmware 634 to specify clock and bus speeds, define what peripherals are attached to the system 600, set monitoring of health (e.g., fan speeds and CPU temperature limits), and/or provide a variety of other parameters that affect overall performance and power usage of the system 600. While firmware 634 is illustrated as being stored in the flash memory 632, one of ordinary skill in the art will readily recognize that the firmware 634 can be stored in other memory components, such as memory 604 or ROM 606.

System 600 can include one or more sensors 626. The one or more sensors 626 can include, for example, one or more temperature sensors, thermal sensors, oxygen sensors, chemical sensors, noise sensors, heat sensors, current sensors, voltage detectors, air flow sensors, flow sensors, infrared thermometers, heat flux sensors, thermometers, pyrometers, etc. The one or more sensors 626 can communicate with the processor, cache 628, flash memory 632, communications interface 624, memory 604, ROM 606, RAM 608, controller 610, and storage device 612, via the bus 602, for example. The one or more sensors 626 can also communicate with other components in the system via one or more different means, such as inter-integrated circuit (I2C), general purpose output (GPO), and the like. Different types of sensors (e.g., sensors 626) on the system 600 can also report to the controller 610 on parameters, such as cooling fan speeds, power status, operating system (OS) status, hardware status, and so forth. A display 636 may be used by the system 600 to provide graphics related to the applications that are executed by the controller 610.

FIG. 7 illustrates an example computer system 700 having a chipset architecture that can be used in executing the described method(s) or operations, and generating and displaying a graphical user interface (GUI). Computer system 700 can include computer hardware, software, and firmware that can be used to implement the disclosed technology. System 700 can include a processor 710, representative of a variety of physically and/or logically distinct resources capable of executing software, firmware, and hardware configured to perform identified computations. Processor 710 can communicate with a chipset 702 that can control input to and output from processor 710. In this example, chipset 702 outputs information to output device 714, such as a display, and can read and write information to storage device 716. The storage device 716 can include magnetic media, and solid state media, for example. Chipset 702 can also read data from and write data to RAM 718. A bridge 704 for interfacing with a variety of user interface components 706, can be provided for interfacing with chipset 702. User interface components 706 can include a keyboard, a microphone, touch detection, and processing circuitry, and a pointing device, such as a mouse.

Chipset 702 can also interface with one or more communication interfaces 708 that can have different physical interfaces. Such communication interfaces can include interfaces for wired and wireless local area networks, for broadband wireless networks, and for personal area networks. Further, the machine can receive inputs from a user via user interface components 706, and execute appropriate functions, such as browsing functions by interpreting these inputs using processor 710.

Moreover, chipset 702 can also communicate with firmware 712, which can be executed by the computer system 700 when powering on. The firmware 712 can recognize, initialize, and test hardware present in the computer system 700 based on a set of firmware configurations. The firmware 712 can perform a self-test, such as a POST, on the system 700. The self-test can test the functionality of the various hardware components 702-718. The firmware 712 can address and allocate an area in the memory 718 to store an OS. The firmware 712 can load a boot loader and/or OS, and give control of the system 700 to the OS. In some cases, the firmware 712 can communicate with the hardware components 702-710 and 714-718. Here, the firmware 712 can communicate with the hardware components 702-710 and 714-718 through the chipset 702, and/or through one or more other components. In some cases, the firmware 712 can communicate directly with the hardware components 702-710 and 714-718.

It can be appreciated that example systems 600 (in FIG. 6) and 700 can have more than one processor (e.g., 630, 710), or be part of a group or cluster of computing devices networked together to provide greater processing capability.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware, generalized hardware made specialized by the execution of software thereon that enables the hardware to perform specific function, software stored on a computer-readable medium, or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A system for providing a single sign-on for a client device, the system comprising:
a virtual infrastructure that provides a virtual machine to the client device in communication with the virtual infrastructure, the virtual infrastructure including a server, an enterprise connector, and a certificate authority generating login certificates;
a credential service coupled to the enterprise connector and the client device; and
an interface providing communication via a remote display protocol between the virtual machine and a client display application executed on the client device, wherein when a user of the client device is authenticated by an identity provider to execute the client display application, a login certificate is received from the certificate authority through the enterprise connector and the credential service, and wherein the login certificate is sent to the virtual infrastructure to allow the client device access to the virtual machine by the client device through the remote display protocol.

2. The system of claim 1, wherein the identity provider sends a token to the client device to allow the user to execute the client display application to send the login certificate to the virtual infrastructure.

3. The system of claim 2, wherein the login certificate has an expiration period and is stored in a security container on the client device.

4. The system of claim 3, wherein the client device includes a credential controller that checks the stored login certificate and determines if the login certificate has expired in a subsequent authentication of the user, and wherein if the login certificate has not expired, the stored login certificate is sent to the virtual infrastructure to allow the client device access to the virtual machine by the client device through the remote display protocol.

5. The system of claim 3, wherein the security container is a virtual smart card stored on a Trusted Platform Module of the client device or an encrypted storage of the client device.

6. The system of claim 2, wherein the token is sent to the credential service to request the generation of the login certificate from the certificate authority through the enterprise connector.

7. The system of claim 1, further comprising a desktop control plane coupled to the virtual infrastructure and the client device, wherein the credential service is part of the desktop control plane.

8. The system of claim 1, wherein the interface is a gateway in communication with the virtual machine and the client device, wherein the user is an external user to the virtual infrastructure and on sending the login certificate, the gateway allows communication between the virtual machine and the client device.

9. The system of claim 1, wherein the client device is a component of the virtual infrastructure, and wherein the user is an internal user and on sending the login certificate and direct communication between the virtual machine and the client device is allowed.

10. The system of claim 1, wherein the certificate authority is a Microsoft Active Directory system.

11. A method for allowing a single sign-on for connecting a client device to a virtual machine generated by a virtual infrastructure including a server executing the virtual machine, an interface to the client device, an enterprise connector and a certificate authority, the method comprising:
receiving authentication by an identity provider of a user of the client device through the enterprise connector;
validating the authentication provided by the identity provider;
generating a login certificate by the certificate authority;
sending the login certificate to a client display application executed on the client device;
receiving the login certificate sent by the client device at the virtual infrastructure; and
allowing communication between the client device and the virtual machine on receiving the login certificate.

12. The method of claim 11, wherein the identity provider sends a token to the client device to allow the user to execute the client display application using the login certificate to the virtual infrastructure.

13. The method of claim 12, wherein the login certificate has an expiration period and is stored in a security container on the client device.

14. The method of claim 13, further comprising:
on a subsequent authorization of the user, checking the stored login certificate to determine if the login certificate has expired;
sending the stored login certificate to the virtual infrastructure if the login certificate has not expired; and
allowing communication between the client device and the virtual machine on receiving the stored login certificate.

15. The method of claim 13, wherein the security container is a virtual smart card stored on a Trusted Platform Module of the client device or an encrypted storage of the client device.

16. The method of claim 12, wherein the token is sent to a credential service to request the generation of a new login certificate from the certificate authority through an enterprise connector.

17. The method of claim 11, wherein a credential service is part of a desktop control plane coupled to the client device and the virtual infrastructure, wherein the credential service receives the generated login certificate through the enterprise connector and sends the login certificate to the client device.

18. The method of claim 11, wherein a gateway is in communication with the virtual machine and the client device, wherein the user is an external user to the virtual infrastructure and on sending the login certificate, the gateway allows communication between the virtual machine and the client device.

19. The method of claim 11, wherein the client device is a component of the virtual infrastructure, and wherein the user is an internal user and on sending the login certificate, direct communication between the virtual machine and the client device is allowed.

20. A non-transitory computer-readable medium having machine-readable instructions stored thereon, which when executed by a processor, cause the processor to perform the steps of:
receiving authentication by an identity provider of a user of a client device through an enterprise connector of a virtual infrastructure;
validating the authentication provided by the identity provider;
generating a login certificate by a certificate authority;
sending the login certificate to a client display application executed on the client device;
receiving the login certificate at the virtual infrastructure; and
allowing communication between the client device and a virtual machine on receiving the login certificate.
